(19) United States
(12) Patent Application Publication
(10) Pub. No.: US 2024/0006608 A1
(43) Pub. Date: Jan. 4, 2024

(54) MICRON- AND SUBMICRON-SIZED LITHIUM IRON PHOSPHATE PARTICLES AND METHOD OF PRODUCING SAME

(71) Applicant: Rivian IP Holdings, LLC, Irvine, CA (US)

(72) Inventors: Soo Kim, Fremont, CA (US); Rubayyat Mahbub, Fremont, CA (US); Majid Talebiesfandarani, Emeryville, CA (US); Sun Ung Kim, Camas, WA (US); Sookyung Jeong, San Jose, CA (US); Tae Kyoung Kim, Albany, CA (US); Ki Tae Park, Santa Clara, CA (US); Victor Prajapati, San Francisco, CA (US)

(21) Appl. No.: 17/856,444

(22) Filed: Jul. 1, 2022

(51) Int. Cl. C01B 25/30; H01M 10/0525

(52) U.S. Cl. CPC C01B 25/301; H01M 10/0525; C01P 2006/40; C01P 2004/51

(57) ABSTRACT

An electrode active material includes a dopant (M²) and a lithium iron phosphate host material, where the electrode active material is represented as LiM²ₓFe₁₋ₓPO₄; M² is a transition metal or main group metal; x is 0.01 to 0.15; the electrode active material exhibits an increased ionic conductivity compared to a lithium iron phosphate (LiFePO₄) without the dopant; and the electrode active material has a particle size distribution characterized by a D₅₀ greater than or equal to 1 μm.

### INTRODUCTION

The present technology is generally related to lithium rechargeable batteries. More particularly the technology relates to coatings for lithium iron phosphate electrode active materials.

### SUMMARY

In one aspect, an electrode active material includes a dopant (M²) and a lithium iron phosphate host material, wherein the electrode active material is represented as LiM²ₓFe₁₋ₓPO₄; M² is a transition metal or main group metal; x is 0.01 to 0.15; the electrode active material exhibits an increased ionic conductivity compared to a lithium iron phosphate (LiFePO₄) without the dopant; and the electrode active material has a particle size distribution characterized by a D₅₀ greater than or equal to 1 μm.

In another aspect, a cathode active material includes a core phase of formula LiFePO₄; and a secondary phase of a compound of formula LiM²_{z}PₚO_{p′} at or near the surface of the core phase; where z is 1, 2, or 3; p is 1, 2, 3, or 4; p′ is an integer from about 1 to about 16; M² is Co, Cr, Gd, In, Mn, V, Zr, or a mixture of any two or more thereof; M² is present in the cathode active material from about 0.1 to about 15 mol %; the cathode active material exhibits an increased ionic conductivity compared to LiFePO₄ without the secondary phase; and the cathode active material has a particle size distribution characterized by a D₅₀ greater than or equal to 1 μm.

In a further aspect, a lithium ion battery cell includes an anode layer; a cathode layer; and a separator or solid electrolyte between the anode layer and the cathode layer. In the lithium ion battery, the cathode layer includes a particulate cathode active material having a core phase of formula LiFePO₄; and a secondary phase of a compound of formula LiM²_{z}PₚO_{p′} at or near the surface of the core phase; where z is 1, 2, or 3; p is 1, 2, 3, or 4; p′ is an integer from about 1 to about 16; M² is Co, Cr, Gd, In, Mn, V, Zr, or a mixture of any two or more thereof; M² is present in the cathode active material from about 0.1 to about 15 mol %; the cathode active material exhibits an increased ionic conductivity compared to LiFePO₄ without the secondary phase; and the cathode active material has with a particle size distribution characterized by a D₅₀ greater than or equal to 1 μm; and the cathode layer has a loading level on the current collector (e.g., aluminum foil), greater than 15 mg/cm².

In an additional aspect, a process for preparing an electrode active material includes forming a solution comprising a lithium source, an iron source, dopant source, and a phosphorus source in a solvent; mixing the solution at a predetermined pH and for a period of time to form a precipitate of an intermediate precursor; collecting the precipitate; and annealing the precipitate at an elevated temperature to form a doped lithium iron phosphate (LiM²ₓFe₁₋ₓPO₄) compound, where M² is the dopant and comprises a transition metal or main group metal. In such a process, the LiM²ₓFe₁₋ₓPO₄ is characterized by a D₅₀ greater than or equal to 1 μm; x is 0.01 to 0.15.

In another aspect, an electrochemical cell may include an anode and a cathode that includes any of the electrode active materials described herein as including a doped lithium manganese iron phosphate, where the anode and/or cathode may also include a conductive carbon, a binder, a current collector, or any two or more thereof.

In another aspect, a process is provided for recharging a lithium ion battery that includes any of the doped lithium iron phosphate materials described herein includes applying a charging voltage to the lithium ion battery, wherein a time required to charge the lithium ion battery is less than a lithium ion battery comprising an undoped lithium iron phosphate host material.

In other aspects, a battery cell may be incorporated into a battery pack comprising a plurality of the battery cells. Such batteries, battery cells, or battery packs may then be incorporated in a hybrid electric vehicle or electric vehicle as a power source.

### BRIEF DESCRIPTION OF THE DRAWINGS

FIGS. 1A, 1B, 1C, and 1D include schematic illustrations of various morphologies of doped or coated LiFePO₄, according to various embodiments.

FIG. 2 is a schematic illustration of a double-side coated cathode coating layer on a current collector, illustrating the effect of the loading level and volumetric energy density.

FIG. 3 is an illustration of a cross-sectional view of an electric vehicle, according to various embodiments.

FIG. 4 is a depiction of an illustrative battery pack, according to various embodiments.

FIG. 5 is a depiction of an illustrative battery module, according to various embodiments.

FIGS. 6A, 6B, and 6C are cross sectional illustrations of various batteries, according to various embodiments.

FIG. 7 is a schematic illustration of LiFePO₄ cathode active material, according to the examples

FIG. 8 is a schematic illustration describing Li⁺ ion diffusion in (010) direction in LiFePO₄, according to various embodiments.

FIG. 9 is a comparison of the atomic structure of unmodified (pristine; left) and modified (doped; right) LiFePO₄, according to various embodiments.

FIG. 10 is an illustration of the energy barrier of Li⁺ ion diffusion between the pristine and doped cathode materials in (010) direction, according to various embodiments.

FIG. 11 is a hybrid pulse power characterization (HPPC) test to measure the resistance versus state of charge for undoped-LFP and modified (e.g., doped) LFP, according to various embodiments.

FIG. 12 is a graph of electrochemical impedance spectroscopy (EIS) measurements for undoped-LFP and modified (e.g., doped) LFP, according to various embodiments.

FIG. 13 includes graphs of voltage versus discharge capacity for LFP materials having a D₅₀ of about 100 nm and about 1 μm, according to various embodiments.

FIG. 14 is a graph of electronic conductivity vs. temperature (1/T) for undoped-LFP and modified (e.g., doped) LFP, according to various embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

LiMO₂ (M=Ni, Mn, and/or Co; i.e. “LiNMC” materials) cathode active materials are routinely used in current electric vehicle production due their high energy densities (i.e., high voltage, high capacity). Because passenger electric vehicles and/or mobile electronic devices (i.e. phones, laptops, tablets, and the like) have a very limited space for the placement of rechargeable battery packs, using cathode materials with higher high energy density is of high consideration when designing such devices. As the Ni content increases in LiNMC cathodes, the battery thermal stability is also affected, leading to various safety issues and concerns.

Lithium iron phosphate (LiFePO₄; “LFP”) is a class of cathode materials, related to LiNMC, but is entirely based upon the oxidation and reduction of the iron. It also provides better safety profiles when compared to LiNMC materials. However, the energy density of LFP tends to be lower than that of LiNMC-based cathodes. The average cell voltage of LFP is about 3.2 V vs. graphite, while the average voltage of LiMO₂ (lithium metal oxide) cathode materials varies from about 3.4 to 4.0 V vs. graphite, depending on the metal. In addition, the practical capacity of LFP materials is from about 150 mAh/g to about 165 mAh/g, compared to LiNMC material that exhibit capacities of about 170 mAh/g to about 210 mAh/g. As used herein, the energy density is defined as the product of voltage and capacity; therefore, the energy density of LFP is expected to be lower than LiNMC materials.

LFP cathode materials are typically prepared as nano-sized particles to decrease the Li⁺ ion diffusion length. However, when the LFP particle size is reduced, it is more difficult to achieve a high energy density design for electric vehicle applications, because the loading level (mg/cm²) and packing density (g/cm³) are both also reduced. Accordingly, there is an effort to increase the LFP particle size to those having a D₅₀ of about 1 μm or greater. While these larger-sized LFP can still deliver a relatively high capacity of 140-150 mAh/g at a lower C-rate (e.g., C/3, normal operating condition), their rate capabilities at higher C-rate above 1C are significantly slow (i.e., fast charging/discharging conditions).

Disclosed herein are secondary coating materials for larger format cathode active LiFePO₄ (LFP) materials, to help improve their energy density. Specifically, disclosed herein are commercially available LiFePO₄ materials having a D₅₀ of greater than 1 μm, and which are provided with a first coating that may not be uniform, or that may have defects that are then filled/addressed by the secondary coating. The resulting dual coated LFP materials are expected to exhibit an increased ionic conductivity in the Li⁺ ion channel path, and an enhanced electronic conductivity and rate capabilities to achieve an interface having greater contact between the carbon coating and the surface metal atoms of the commercially available LFP.

In a first aspect, an electrode active material includes a dopant (M²) and a lithium iron phosphate host material represented as LiM²ₓFe₁₋ₓPO₄. In the electrode active material, the dopant may be a transition metal or main group metal, and the electrode active material exhibits an increased ionic conductivity compared to a lithium manganese iron phosphate (LiFePO₄) without the dopant and the electrode active material has a particle size distribution (PSD) characterized by a D₅₀ greater than or equal to 1 μm. In the above formula, x is from 0.01 to 0.15.

The dopant, M² may be Co, Cr, Gd, In, Mn, V, Zr, or a mixture of any two or more thereof. In some embodiments, M² is Co²⁺, Co³⁺, Cr²⁺, Cr³⁺, Gd³⁺, In³⁺, Mn²⁺, mn³⁺, mn⁷⁺, V²⁺, V³⁺, V⁴⁺, Zr⁴⁺, or a mixture of any two or more thereof. Generally, overall, the M² is present in the LiM²ₓMn_{y}Fe_{1-x-y}PO₄ compound from about 1 mol % to about 15 mol %.

The morphology of the electrode active material may take on a variety of shapes. For example, it may be spherical, ovoid, rod-like, disc-shaped, star-shaped, rectangular, ellipsoidal, and the like, and may be determined experimentally by the use of scanning electron microscopy (SEM). The size distributions may be mono-modal (i.e. having a single maxima) or may be bi-modal (i.e. having two maxima) on average. Overall, a particle size analyzer may be used to determine the PSD. In some embodiments, the particle size distribution is characterized by a D₅₀ is from 1 μm to 5 μm. Other particle size descriptors may also be used. For example, the electrode active material has a particle size distribution characterized by a D₁₀ from 100 nm to 0.6 μm. In some embodiments, the electrode active material has a particle size distribution characterized by a D₉₀ from 1.7 μm to 25 μm.

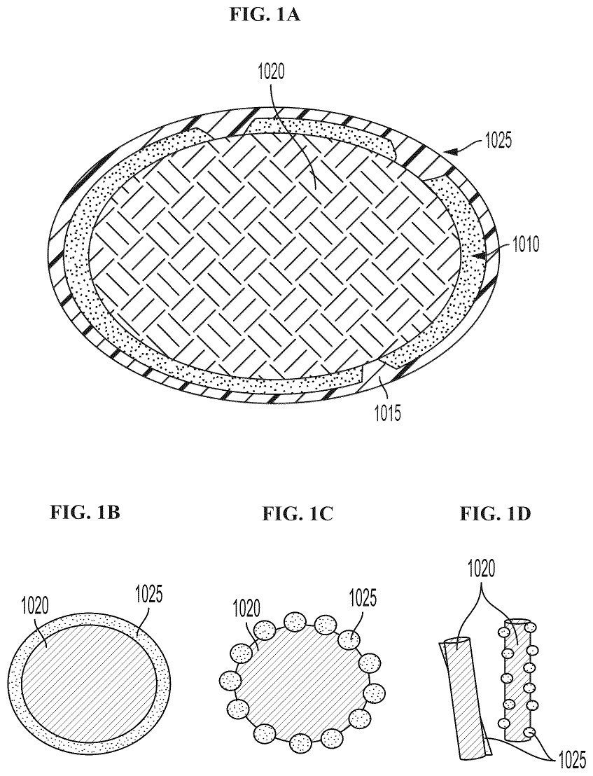

Referring to FIG. 1 that shows various morphologies, the metal dopant or coatings as described herein may form a layer (“shell”) 1025 on the surface of an LiFePO₄ core material 1020 (FIG. 1B), or the metal dopant or coatings may form as discreet particles or “islands” 1030 on the surface of the LiFePO₄ material 1020 that can any of a number of shapes including the spheres or rods in FIGS. 1C and 1D. In some embodiments, the LiFePO₄ 1020 is a commercially sourced and has a first coating layer 1010 that may be discontinuous with gaps 1015 in the layer (FIG. 1A). In such embodiments, the metal dopant or coatings as described herein may fill in the discontinuous regions, or gaps.

To further protect the electrode active material, and provide additional ionic conductivity capacity; the electrode active material may include a carbon coating. The carbon coating may include carbon atoms being sp² hybridized, sp³ hybridized, or combinations thereof. Typically, the ratio between sp² and sp³ type carbons are determined by the choice of carbon coating precusors, as well as heat treatment conditions. The exact ratio between the sp² and sp³ can be determined by Raman Spectroscopy, where the D band is located around 1350 cm⁻¹ and the G band is located around 1620 cm⁻¹. The D and G bands each represent resonance signatures for sp²- and sp³-hybridized carbon, respectively. A typical D/G intensity ratio may vary from 0.8 to 1.2. Lower D/G ratios indicate greater sp²-like carbon, while higher ratios indicate higher sp³-like carbon. Because sp³-type carbon is saturated and sp² carbon is graphene-like, consisting of C-C bonding with π-electron clouds, having more sp² carbon coating will assist in increasing the overall conductivity of the LFP cathode materials.

In another aspect, a cathode active material is provided including a core phase of formula LiFePO₄ and a secondary phase of formula LiM²_{z}PₚO_{p′} at or near the surface of the core phase where the cathode active material has a particle size distribution characterized by a D₅₀ greater than or equal to 1 μm. In these formulae, z is 1, 2, or 3; p is 1, 2, or 3, and p′ is an integer from about 1 to about 16. Additionally, M² may be Co, Cr, Gd, In, Mn, V, Zr, or a mixture of any two or more thereof. The secondary phase of formula LiM²_{z}PₚOₚ, may be present in the host phase at less than about 15 mol %. Interestingly, the cathode active material exhibits an increased ionic conductivity compared to LiFePO₄ without the secondary phase of formula LiM²_{z}PₚOₚ.

The dopant, M 2 may be Co, Cr, Gd, In, Mn, V, Zr, or a mixture of any two or more thereof. In some embodiments, M² is Co²⁺, Co³⁺, Cr²⁺, Cr³⁺, Gd³⁺, In³⁺, Mn²⁺, mn³⁺, mn⁷⁺, V²⁺, V³⁺, V⁴⁺, Zr⁴⁺, or a mixture of any two or more thereof. Generally, overall, the M² is present in the LiM²ₓMn_{y}Fe_{1-x-y}PO₄ compound from about 1 mol % to about 15 mol %. As above, the cathode active material may include a carbon coating.

In the cathode active material, illustrative secondary phases include, but are not limited to, Li₃Mn₃(PO₄)₄, LiVP₂O₇, LiGd(PO₃)₄, LiMn(PO₃)₄, LiCo(PO₃)₄, Li₃Cr₂(PO₄)₃, LiCo(PO₃)₃, LiCoPO₄, LiV(PO₃)₄, LiZr₂(PO₄)₃, LiCrP₂O₇, LiVPO₅, LiInP₂O₇, LiFePO₄, or a mixture of any two or more thereof₃. The secondary phase may be present in the host phase from about 0.01 mol % to about 15 mol %. This may include where the secondary phase is present in the host phase from about 0.01 mol % to about 10 mol %, or from about 0.01 mol % to about 5 mol %.

The electrode active materials tend have a particulate morphology, and in the particles, the secondary phase may be present in the composition at higher concentrations near the surface of the particles compared to the core of the particles. If the interfacial energy between the secondary phase and the host phase is smaller (i.e., easier to form an interface), the secondary phase may be present as nanocomposite with the host cathode materials as a precipitate form, rather than segregating toward the surface region of the particles.

In some embodiments, the particle size distribution of the cathode active material is characterized by a D₅₀ is from 1 μm to 5 μm. In other embodiments, the electrode active material may have a particle size distribution characterized by a D₁₀ from 100 nm to 0.6 μm. In some embodiments, the electrode active material may have a particle size distribution characterized by a D₉₀ from 1.7 μm to 25 μm.

In another aspect, a lithium ion battery cell includes an anode layer, a cathode layer, and a separator or solid electrolyte between the anode layer and the cathode layer. The cathode layer may comprise any of the electrode active or cathode active materials as described herein, and may exhibit a loading level on the current collector (e.g., A1 foil) of greater than 15 mg/cm². In some embodiments, the cathode layer has an electrode loading level from 15 mg/cm² to 25 mg/cm². In other embodiments, the cathode layer has an electrode loading level from 18 mg/cm² to 25 mg/cm², or from 19 mg/cm² to 21 mg/cm².

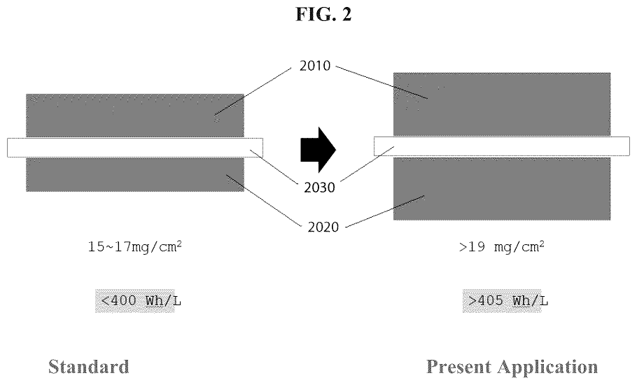

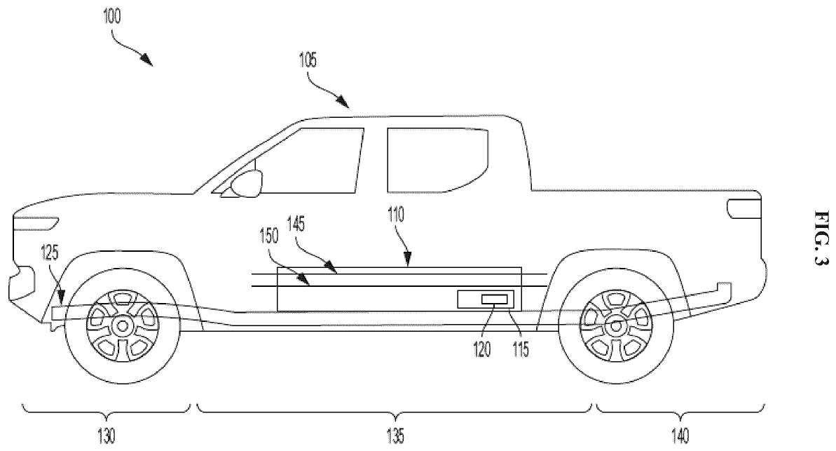

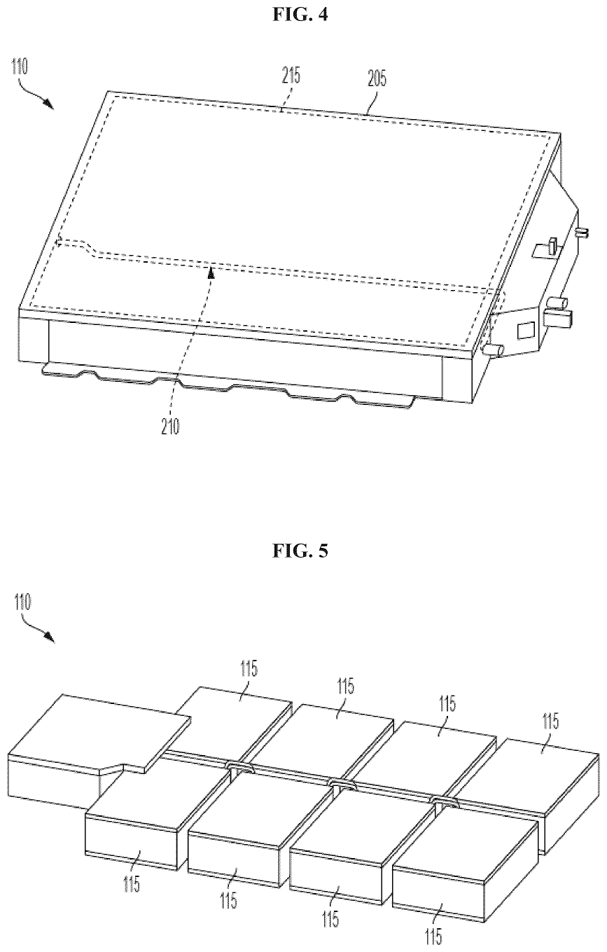

Such loading densities can lead to higher energy density design than in standard rechargeable lithium ion cells. FIG. 2 is a schematic illustration of a battery cell stack including a cathode active material layer 2010, an anode active material layer 2020, and a separator 2030. The stack on the left is a standard size having a loading level from about 15 to 17 mg/cm² and generating up to 400 Wh/L. The stack on the right is an illustration of the present structures, where, according to some embodiments, the higher loading level is greater than 19 mg/cm², and providing greater than 400 Wh/L.

Also provided for herein are processes for preparing the doped lithium iron phosphates (LiM²ₓFe₁₋ₓPO₄), where in such a formula M² represents the dopant that is a transition metal or main group element. The process includes forming a solution that includes a lithium source, an iron source, a dopant source, and a phosphorus source, at the appropriate stoichiometric ratios, in a solvent. The source components and solvent can be distinct compounds, or alternatively they may be a single compound that functions as a source of multiple components (e.g., acidic solvent such as H₃PO₄ can serve as a phosphorus source, or Li₃PO₄ may be both a lithium source and a phosphorus source). The solution is then mixed at a predetermined pH and for a period of time sufficient to form a precipitate of a lithium-metal-phosphorus-oxygen composition that is a precursor the lithium dopant iron phosphate. The precipitate is allowed to grow until a particle size characterized by a D₅₀ of greater than or equal to 1 μm is achieved. The precipitate is then collected and then subjected to an annealing process where the lithium-metal-phosphorus-oxygen composition is heated to convert it to the lithium dopant iron phosphate having a particle size distribution characterized by a D₅₀ of greater than or equal to 1 μm. In the above formula, x is 0.01 to 0.15.

In such a process, illustrative lithium source materials include, but are not limited to, Li₂CO₃, Li₃PO₄, LiOH·H₂O, LiHCO₃ or mixture thereof. The iron source may be any of an iron metal, iron metal oxide, or an iron salt. These may include, but are not limited to Fe⁰, Fe₂O₃, Fe₃O₄, Fe(NO₃)₂, Fe(NO₃)₃, FeCl₂, FeCl₃, FePO₄, FeSO₄, Fe₂(SO₄)₃, or a mixture of any two or more thereof, or a hydrate thereof.

The dopant source may also be the dopant metal as a dopant metal oxide, or as a dopant metal salt. Illustrative dopant sources include, but are not limited to, M² metal, M²_{q}O_{q′}, M²_{q}(NO₃)_{q′}, M²_{q}Cl_{q′}, M²_{q}(PO₄)_{q′}, M²_{q}(SO₄)_{q′}, or a mixture of any two or more thereof, wherein M 2 is Co, Cr, Gd, In, Mn, V, Zr, or a mixture of any two or more thereof, and q and q′ are individually 1, 2, 3, 4, 5, 6, or 7.

In the process, the mixing is conducted at a neutral to acidic pH (i.e. from about 1 to 7). The mixing is also conducted for a time sufficient to nucleate and form a precipitate. The time may range in various embodiments from about 1 minute to 48 hours. In some embodiments, it is from about 1 minute to 24 hours, from about 1 minute to 12 hours, from about 1 minute to 6 hours, or from about 1 minute to about 1 hour. Also noted is the temperature at which the mixing is conducted. Again, the temperature is sufficient to form the precipitate efficiently. The elevated temperature may be from about 50° C. to about 100° C.

In the process, the collecting of the precipitate may include collecting it by filtration, followed by washing with a solvent. Illustrative solvents include, but are not limited to, water, alcohols, ketones, and the like.

The annealing may be conducted in air. In some embodiments, the annealing is conducted in the presence of a gas that may include N₂, H₂, CO, CO₂, or a mixture of any two or more thereof. The annealing may be conducted at an elevated temperature. For example at a temperature of greater than about 200° C. This may include temperatures from 200° C. to 1500° C., from 400° C. to 1500° C., from 200° C. to 1200° C., from 400° C. to 1200° C., from 200° C. to 1000° C., from 600° C. to 800° C., from 600° C. to 750° C., or from 400° C. to 1000° C.

In another aspect, an electrochemical cell may include an anode and a cathode that includes any of the electrode active materials described herein as including a doped lithium iron phosphate. In such embodiments, the anode and/or cathode may also include a conductive carbon (in addition to any carbon coatings that may be included), a binder, a current collector, or any two or more thereof. The cathode may include any of the cathode active materials as described herein.

Illustrative conductive carbon species include graphite, carbon black, Super P carbon black material, Ketjen Black, Acetylene Black, SWCNT, MWCNT, graphite, carbon nanofiber, and/or graphene, graphite. Illustrative binders may include, but are not limited to, polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrilic acid (PAA), poly(methyl acrylate) (PMA), poly(vinyl alcohol) (PVA) , poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof. The current collector may include a metal that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or combination thereof. In another embodiment, the metal foils maybe coated with carbon: e.g., carbon-coated Al foil, and the like.

The anodes of the electrochemical cells may include lithium. In some embodiments, the anodes may also include a current collector, a conductive carbon, a binder, and other additives, as described above with regard to the cathode current collectors, conductive carbon, binders, and other additives. In some embodiments, the electrode may comprise a current collector (e.g., Cu foil) with an in situ-formed anode (e.g., Li metal) on a surface of the current collector facing the separator or solid-state electrolyte such that in an uncharged state, the assembled cell does not comprise an anode active material.

The electrochemical cells may also include an electrolyte. The electrolyte may be solution-based electrolyte that includes, typically, a lithium salt and carbonate, ionic liquid, or ether solvent.

The electrochemical cells described herein may be a lithium ion battery.

In another aspect, a process is provided for recharging a lithium ion battery that includes any of the doped lithium manganese iron phosphate materials described herein. The process of recharging may include applying a charging voltage to the lithium ion battery, wherein a time required to charge the lithium ion battery is less than a lithium ion battery including an undoped lithium iron phosphate.

In another aspect, the present disclosure provides a battery pack comprising the cathode active material, the electrochemical cell, or the lithium ion battery of any one of the above embodiments. The battery pack may find a wide variety of applications including but are not limited to general energy storage or in vehicles. In another aspect, a plurality of battery cells as described above may be used to form a battery and/or a battery pack, which may find a wide variety of applications such as general storage, or in vehicles.

By way of illustration of the use of such batteries or battery packs in an electric vehicle, FIG. 3 depicts an illustrative cross-sectional view 100 of an electric vehicle 105 installed with at least one battery pack 110. Electric vehicle 105 may include an electric truck, electric sport utility vehicle (SUV), electric delivery van, electric automobile, electric car, electric motorcycle, electric scooter, electric passenger vehicle, electric passenger truck, electric commercial truck, hybrid vehicle, or other vehicle such as a sea or air transport vehicle, airplane, helicopter, submarine, boat, or drone, among other possibilities. The battery pack 110 may also be used as an energy storage system to power a building, such as a residential home, or commercial building. Electric vehicles 105 may be fully electric or partially electric (e.g., plug-in hybrid), and they may be fully autonomous, partially autonomous, or unmanned. Electric vehicles 105 can also be human operated or non-autonomous.

Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

FIG. 4 depicts an illustrative battery pack 110. Referring to FIG. 4, among others, the battery pack 110 may provide power to electric vehicle 105. Battery packs 110 may include any arrangement or network of electrical, electronic, mechanical, or electromechanical devices to power a vehicle of any type, such as the electric vehicle 105. The battery pack 110 may include at least one housing 205. The housing 205 may include at least one battery module 115 or at least one battery cell 120, as well as other battery pack components. The housing 205 may include a shield on the bottom or underneath the battery module 115 to protect the battery module 115 from external conditions, for example if the electric vehicle 105 is driven over rough terrain (e.g., off-road, trenches, rocks, etc.) The battery pack 110 may include at least one cooling line 210 that can distribute fluid through the battery pack 110 as part of a thermal/temperature control or heat exchange system that may also include at least one cold plate 215. The cold plate 215 may be positioned in relation to a top submodule and a bottom submodule, such as in between the top and bottom submodules, among other possibilities. The battery pack 110 may include any number of cold plates 215. For example, there may be one or more cold plates 215 per battery pack 110, or per battery module 115. At least one cooling line 210 may be coupled with, part of, or independent from the cold plate 215.

FIG. 5 depicts illustrative battery modules 115. The battery modules 115 may include at least one submodule. For example, the battery modules 115 may include at least one first (e.g., top) submodule 220 or at least one second (e.g., bottom) submodule 225. At least one cold plate 215 may be disposed between the top submodule 220 and the bottom submodule 225. For example, one cold plate 215 may be configured for heat exchange with one battery module 115. The cold plate 215 may be disposed within, or thermally coupled between, the top submodule 220 and the bottom submodule 225. One cold plate 215 may also be thermally coupled with more than one battery module 115 (or more than two submodules 220, 225). The battery submodules 220, 225 may collectively form one battery module 115. In some embodiments, each submodule 220, 225 may be considered as a complete battery module 115, rather than a submodule.

The battery modules 115 may each include a plurality of battery cells 120. The battery modules 115 may be disposed within the housing 205 of the battery pack 110. The battery modules 115 may include battery cells 120 that are cylindrical cells, prismatic cells, or other form factor cells. The battery module 115 may operate as a modular unit of battery cells 120. As an illustration, a battery module 115 may collect current or electrical power from the battery cells 120 that are included in the battery module 115 and may provide the current or electrical power as output from the battery pack 110. The battery pack 110 may include any number of battery modules 115. For example, the battery pack may have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a cold plate 215 between the top submodule 220 and the bottom submodule 225. The battery pack 110 may include, or define, a plurality of areas for positioning of the battery module 115. The battery modules 115 may be square, rectangular, circular, triangular, symmetrical, or asymmetrical. In some embodiments, battery modules 115 may be different shapes, such that some battery modules 115 are rectangular but other battery modules 115 are square shaped, among other possibilities. The battery module 115 may include or define a plurality of slots, holders, or containers for a plurality of battery cells 120.

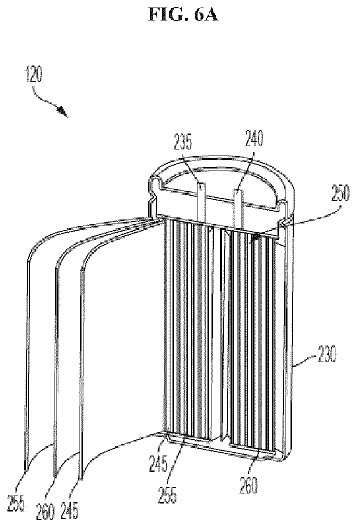

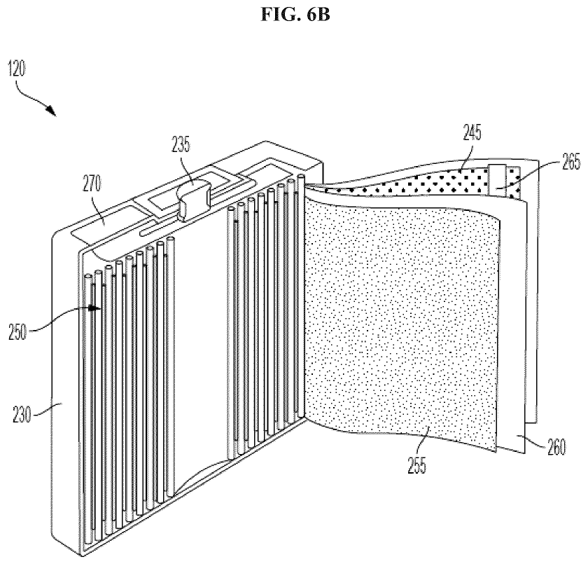

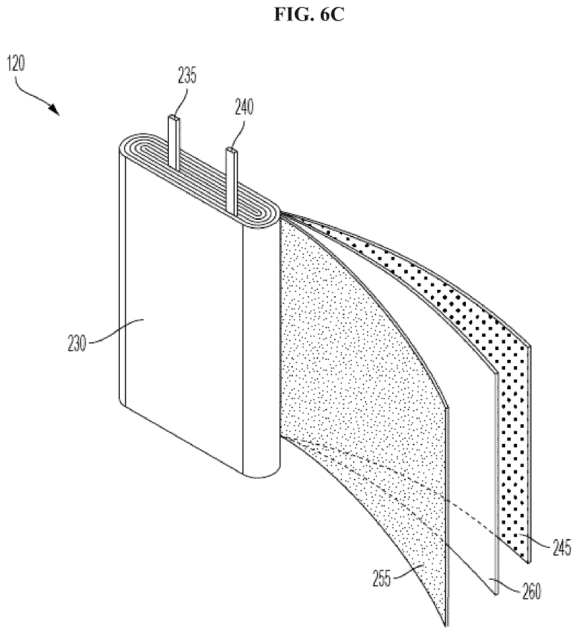

As noted above, battery cells 120 have a variety of form factors, shapes, or sizes. For example, battery cells 120 may have a cylindrical, rectangular, square, cubic, flat, or prismatic form factor. FIGS. 6A, 6B, and 6C depict illustrative cross sectional views of battery cells 120 in such various form factors. For example FIG. 6A is a cylindrical cell, 6B is a prismatic cell, and 6C is the cell for use in a pouch. The battery cells 120 may be assembled by inserting a wound or stacked electrode roll (e.g., a jellyroll) including electrolyte material into at least one battery cell housing 230. The electrolyte material, e.g., an ionically conductive fluid or other material, may generate or provide electric power for the battery cell 120. A first portion of the electrolyte material may have a first polarity, and a second portion of the electrolyte material may have a second polarity. The housing 230 may be of various shapes, including cylindrical or rectangular, for example. Electrical connections may be made between the electrolyte material and components of the battery cell 120. For example, electrical connections with at least some of the electrolyte material may be formed at two points or areas of the battery cell 120, for example to form a first polarity terminal 235 (e.g., a positive or anode terminal) and a second polarity terminal 240 (e.g., a negative or cathode terminal). The polarity terminals may be made from electrically conductive materials to carry electrical current from the battery cell 120 to an electrical load, such as a component or system of the electric vehicle 105.

As illustrated in FIGS. 6A-6C, the housing 230 of the battery cell 120 may include one or more materials with various electrical conductivity or thermal conductivity, or a combination thereof. The electrically conductive and thermally conductive material for the housing 230 of the battery cell 120 may include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 may include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

The battery cell 120 may include at least one anode layer 245, which may be disposed within the cavity 250 defined by the housing 230. The anode layer 245 may receive electrical current into the battery cell 120 and output electrons during the operation of the battery cell 120 (e.g., charging or discharging of the battery cell 120). The anode layer 245 may include an active substance.

The battery cell 120 may include at least one cathode layer 255 (e.g., a composite cathode layer compound cathode layer, a compound cathode, a composite cathode, or a cathode). The cathode layer 255 may be disposed within the cavity 250. The cathode layer 255 may output electrical current out from the battery cell 120 and may receive electrons during the discharging of the battery cell 120. The cathode layer 255 may also release lithium ions during the discharging of the battery cell 120. Conversely, the cathode layer 255 may receive electrical current into the battery cell 120 and may output electrons during the charging of the battery cell 120. The cathode layer 255 may receive lithium ions during the charging of the battery cell 120.

The battery cell 120 may include a polymer separator comprising a liquid electrolyte in the case of Li-ion batteries or an electrolyte layer 260 in the case of solid-state batteries, disposed within the cavity 250. The separator or solid-electrolyte layer 260 may be arranged between the anode layer 245 and the cathode layer 255 to separate the anode layer 245 and the cathode layer 255. The liquid or solid electrolytes may transfer cations (e.g., Li⁺ ions) from the anode layer 245 to the cathode layer 255 during a discharge operation of the battery cell 120, and vice versa during charging.

FIG. 6B is an illustration of a prismatic battery cell 120. The prismatic battery cell 120 may have a housing 230 that defines a rigid enclosure. The housing 230 may have a polygonal base, such as a triangle, square, rectangle, pentagon, among others. For example, the housing 230 of the prismatic battery cell 120 may define a rectangular box. The prismatic battery cell 120 may include at least one anode layer 245, at least one cathode layer 255, and at least one electrolyte layer 260 disposed within the housing 230. The prismatic battery cell 120 may include a plurality of anode layers 245, cathode layers 255, and electrolyte layers 260. For example, the layers 245, 255, 260 may be stacked or in a form of a flattened spiral. The prismatic battery cell 120 may include an anode tab 265. The anode tab 265 may contact the anode layer 245 and facilitate energy transfer between the prismatic battery cell 120 and an external component. For example, the anode tab 265 may exit the housing 230 or electrically couple with a positive terminal 235 to transfer energy between the prismatic battery cell 120 and an external component.

The battery cell 120 may also include a pressure vent 270. The pressure vent 270 may be disposed in the housing 230. The pressure vent 270 may provide pressure relief to the battery cell 120 as pressure increases within the battery cell 120. For example, gases may build up within the housing 230 of the battery cell 120. The pressure vent 270 may provide a path for the gases to exit the housing 230 when the pressure within the battery cell 120 reaches a threshold.

The present invention, thus generally described, will be understood more readily by reference to the following examples, which are provided by way of illustration and are not intended to be limiting of the present invention.

### EXAMPLES

General. First-principles density functional theory (DFT)-based methodologies combined with machine learning algorithm can be used to determine, understand, and pre-select materials exhibiting the desired properties to modify the lithium iron phosphate materials described herein. The DFT algorithms are used calculate the thermodynamic stability of the materials, to identify those material shaving stable ground state structures vs. high-energy structures. The DFT algorithms may be used to also determine the electrochemical properties such as average voltage (V̅) between x=x₁ and x₂ in LiM²ₓFe₁₋ₓPO₄ materials by using the Gibbs free energy (ΔG) obtained from the internal DFT energy (E) calculations according to the following equation:

$$\overline{V} = - \frac{Δ G}{( {x}_{2} - {x}_{1} ) n e} \approx - \frac{{E}_{L {i}_{{x}_{2}} M X} - {E}_{L {i}_{{x}_{1}} M X} - n {E}_{L i}}{( {x}_{2} - {x}_{1} ) n e}$$

Using DFT, various candidate materials were identified. Table 1 is a listing of potential candidates for doped materials.

TABLE 1
List of lithium metal phosphates that may be considered for inclusion as a dopant
in or coating on LiFePO₄ cathode active materials. The table include the conductivity
and operating voltage for each compared to the reference LiFePO₄.

| Li-M-P-O | σ [S/cm] | V vs. Li/Li⁺ | Classification |
|---|---|---|---|
| Li₃Mn₃(PO₄)₄ | 1.763 × 10⁻⁶ | 4.82 | High voltage, ionically conductive coating |
| LiVP₂O₇ | 1.365 × 10⁻⁶ | 3.87 | Medium-high voltage, ionically |
| | | | conductive coating |
| LiGd(PO₃)₄ | 8.721 × 10⁻⁷ | N/A | Non-redox active, ionically conductive |
| | | | coating |
| LiMn(PO₃)₄ | 7.603 × 10⁻⁷ | 3.72 | Medium-high voltage, ionically |
| | | | conductive coating |
| LiCo(PO₃)₄ | 7.265 × 10⁻⁷ | 6.19 | High voltage, ionically conductive coating |
| Li₃Cr₂(PO₄)₃ | 6.167 × 10⁻⁷ | 4.44 | High voltage, ionically conductive coating |
| LiCo(PO₃)₃ | 5.335 × 10⁻⁷ | 5.25 | High voltage, ionically conductive coating |
| LiCoPO₄ | 3.636 × 10⁻⁷ | 4.80 | High voltage, ionically conductive coating |
| LiV(PO₃)₄ | 1.842 × 10⁻⁷ | 4.71 | High voltage, ionically conductive coating |
| LiZr₂(PO₄)₃ | 4.190 × 10⁻⁸ | N/A | Non-redox active, ionically conductive |
| | | | coating |
| LiCrP₂O₇ | 3.306 × 10⁻⁸ | 4.69 | High voltage, ionically conductive coating |
| LiVPO₅ | 2.985 × 10⁻⁸ | 3.66 | Medium-high voltage, ionically |
| | | | conductive coating |
| LiInP₂O₇ | 1.186 × 10⁻⁸ | N/A | Non-redox active, ionically conductive |
| | | | coating |
| LiFePO₄ | 4.452 × 10⁻¹¹ | 3.50 | Reference |

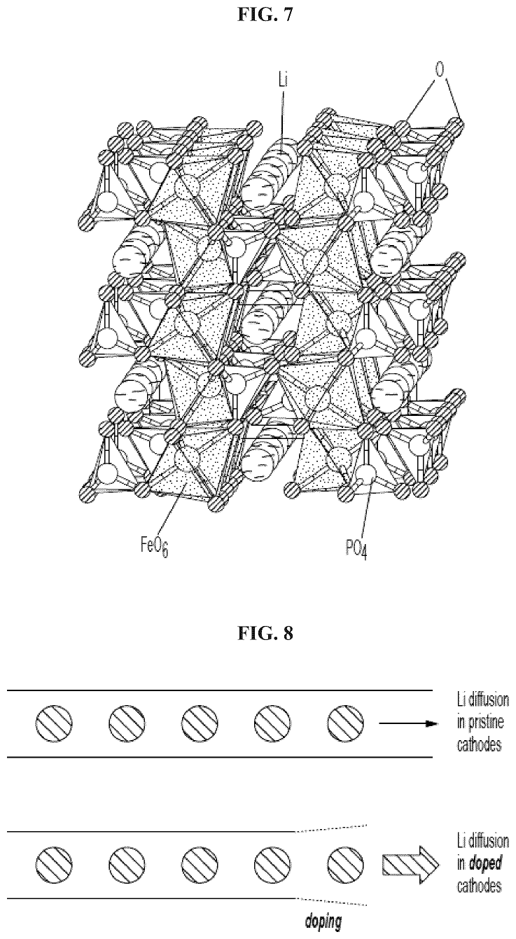

Ionic conductivity is an important measure to determine how fast Li⁺ ions can move in and out of a host electrode structure. FIG. 7 is a schematic illustration of an LiFePO₄ (M=Fe, Mn, etc.) cathode material. In the cathode structure, the Li⁺ ions enter and exit via (010) direction, i.e., 1D Li⁺ channel, toward in/out of the page.

FIG. 8 is a schematic illustration describing Li⁺ ion diffusion in the cathode materials. In the pristine cathode materials, Li⁺ ions travel through (010) direction, where Li⁺ ions are surrounded by the FeO₆ and PO₄ polyhedron units. When a new dopant is introduced at the metal site, the local atomic interaction between Li⁺ ions and the FeO₆ octahedra may be affected accordingly. At the same time, local structure distortion may significantly affect the Li⁺ ion diffusion channel thickness, length, and/or shape.

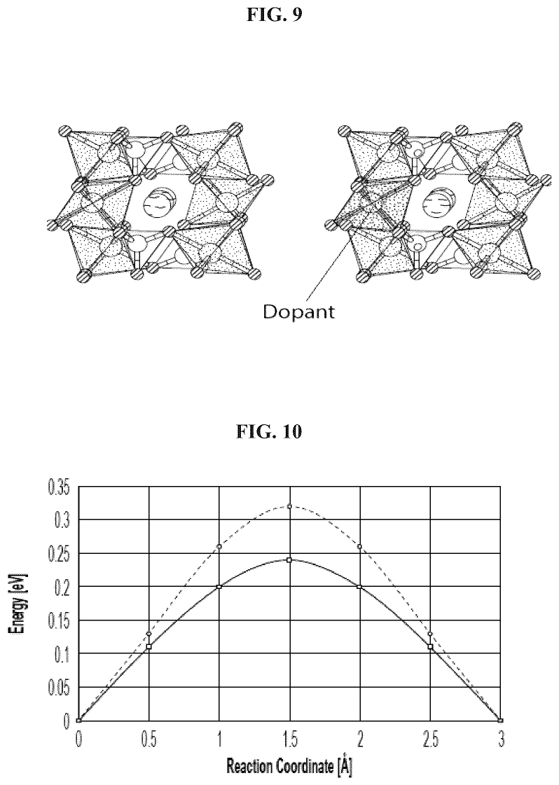

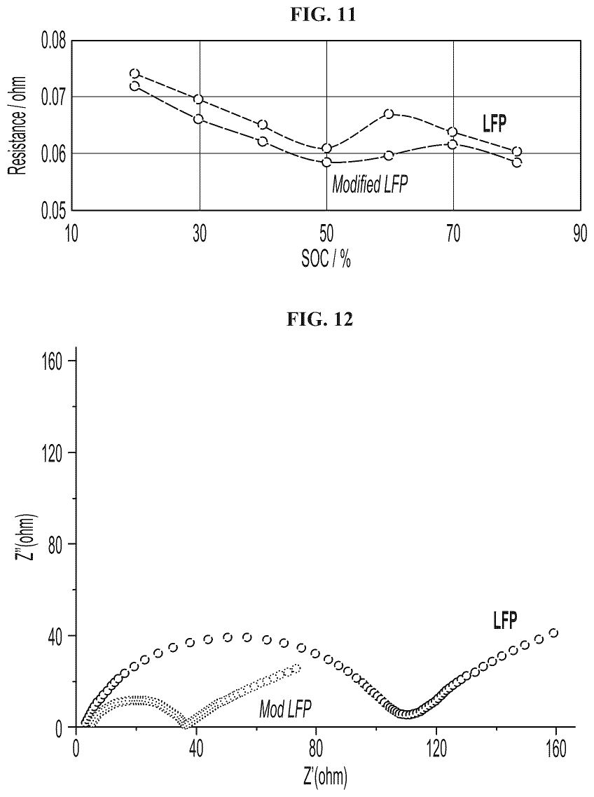

FIG. 9 is a comparison of the atomic structure of pristine (left) and doped (right) cathode materials. As demonstrated below, the local interaction between FeO₆, PO₄, and Li⁺ ions is affected due to an abrupt structural distortion in the (transition) metal sublattice. FIG. 10 is an illustration of the energy barrier of Li⁺ ion diffusion between the pristine and doped cathode materials in (010) direction. The lower the energy barrier is the more facile Li⁺ ion diffusion is within the material. FIG. 11 is a hybrid pulse power characterization (HPPC) measurement at different state of charge (SOCs). HPPC testing may assist in determining the power capability over the EV cell's usable voltage range. A short discharge pulse will generate resistance (i.e., V=I*R) mimicing the charging/discharging process that may occur on the EV during acceleration and regenerative breaking. Typically, lower resistance will be more beneficial, and can assist in the EV acceleration and performance.

FIG. 12 is a graph of electrochemical impedance spectroscopy measurements. In the figure, the semicircles (typically two semicircles, or one, if one is much smaller than another one) refer to solid-electrolyte interface (SEI) resistance and charge transfer resistance. Smaller the semicircles, less SEI and/or charge transfer resistance. In FIG. 12. LFP has larger semicircle (diamond) than modified LFP (circle). Warbug impedance gives a straight line with a phase of 45 degree angle. In FIG. 12, a straight line is shown for LFP (diamond) and modified LFP (circle), where the semicircles end. Higher slope indicates a better solid state diffusion. Overall, the modified LFP has lower SEI and charge transfer resistances, while the solid state diffusion is similar to the pristine sample, where the angle is similar to one another, around 30˜40 degree. In summary, overall resistance of modified LFP (circle) is found to be much lower than the pristine LFP (diamond).

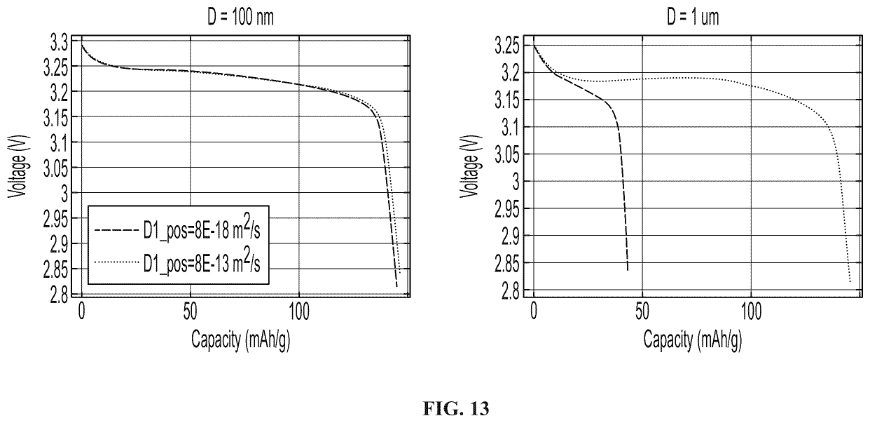

FIG. 13 illustrates the effect of particle size on diffusivity. For the modified LFP, diffisivity is higher (˜10⁻¹³ m²/s), while pristine LFP's diffusivity is lower (˜10⁻¹⁸m²/s). When average particle size is 100 nm, such diffusivity difference does not make too much difference in order to obtain full capacities as shown in the left panel. However, if the average particle size is larger (e.g., 1 μm), because the diffusion length is long but diffusivity is low, it is possible to only obtain a fraction of discharge capacity (as shown in the right panel).

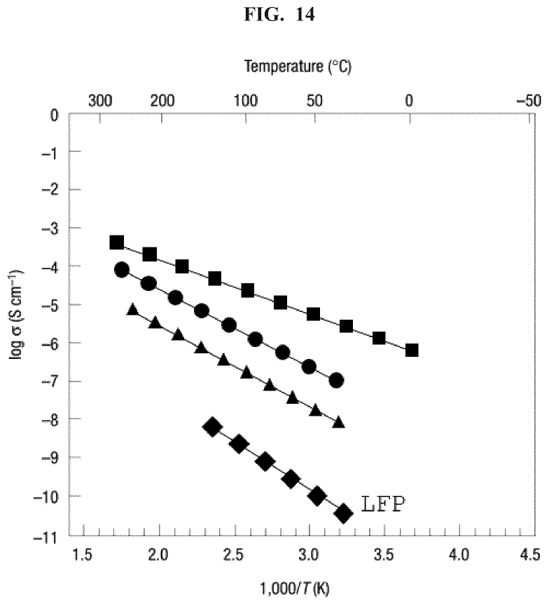

FIG. 14 is log of electronic conductivity vs. 1/T (i.e. an “Arrehenius plot”). The figure shows a strong temperature dependence of conducitivty for various LFP materials being tested. For example, pristine LFP has lowest electronic conductivity, while modified LFPs have higher conductivities at all temperature ranges.

Experimental procedure. LFP precursor materials will be mixed with another targeted metal dopants using solution-based approach with a mixing time varying from 5 min to 24 hours. Lithium sources include Li₂CO₃, Li₃PO₄, LiOH, LiHCO₃, or a mixture of any two or more thereof. The metal sources will be in forms of pure metal powder, oxides (MOₓ), nitrates (M(NO₃)ₓ), chlorides (MClₓ), sulfates (M(SO₄)ₓ), etc. The PO₄ sources including but not limited to H₃PO₄, (NH₄)₂HPO₄, NH₄H₂PO₄ to form a new M-P-O intermediate precursor. The pH of the solution may be controlled by the presence of acid/base and/or oxidizing/reducing agents.

The mixture will then be dried and annealed at elevated temperature. For example, at or between any range of any two of the following values: 50, 75, 100, 125, 150, 200, 400, 500, 600, 700, 800, and 900° C. An aging time (the time from mixing to isolation of the MPO precursor) may be any of the following values or in a range of any two of the following values: 1, 2, 3, 4, 5, 10, 20, 30, 40, and 50 minutes; or, 1, 2, 3, 4, 8, 12, 16, or 24 hours. Changing the reaction time, precursor, temperatures, and the like will affect the mixing tendency between Fe, and a dopant in LFP. Typically, reducing heat treatment conditions may be controlled by the presence of different gas agents including but not limited to N₂, H₂, CO, CO₂, or a mixture of any two or more thereof, as well as the source of carbon-containing hydrocarbon including but not limited to sucrose, glucose, citric acid, oleic acid, acetylene black, citric acid, oxalic acid, L-Ascorbic acid, or mixtures of any two or more thereof.

Active materials containing modified, metal-doped, LFP-based cathode may be mixed with conductive agents such as carbon/CNT and binder materials in an NMP (N-methylpyrrolidone) solution to form a slurry. The slurry may then be coated onto a carbon-coated Al foil, and then dried in the oven to remove the NMP. The loading level of cathode materials may be from about 10 to 40 mg/cm², while the packing density of the materials may vary from 1.5 to 4.0 g/cc.

Electrodes may be assembled as the cathode in Li-ion batteries, where the anode materials may include Li metal, graphite, Si, SiOₓ, Si nanowire, lithiated Si, or a mixture of any two or more thereof. A traditional liquid electrolyte with a LiPF₆ salt, dissolved in a carbonate solution may be used. In one embodiment, an amount of sacrificial Li salt may be added to accommodate the Li loss for the SEI formation on the anode side.

In another embodiment, a solid-state electrolyte includes oxide, sulfide, or phosphate-based crystalline materials as replacement for liquid electrolytes. The cell configuration may be prismatic, cylindrical, or pouch type. Each cell can further be configured together to design pack, module, or stack with a desired power output.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions that can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A electrode active material comprising a dopant (M²) and a lithium iron phosphate host material, wherein:
the electrode active material is represented as LiM²ₓFe₁₋ₓPO₄;
M² is a transition metal or main group metal;
x is 0.01 to 0.15;
the electrode active material exhibits an increased ionic conductivity compared to a lithium iron phosphate (LiFePO₄) without the dopant; and
the electrode active material has a particle size distribution characterized by a D₅₀ greater than or equal to 1 μm.

2. The electrode active material of claim 1, wherein M² is Co, Cr, Gd, In, Mn, V, Zr, or a mixture of any two or more thereof.

3. The electrode active material of claim 1, wherein M² is Co²⁺, Co³⁺, Cr²⁺, Cr³⁺, Gd³⁺, In³⁺, Mn²⁺,mn³⁺, mn⁷⁺, V²⁺, V³⁺, V⁴⁺, Zr⁴⁺, or a mixture of any two or more thereof.

4. The electrode active material of claim 1, wherein the dopant is present in the LiM²ₓFe₁₋ₓPO₄ compound from about 1 mol % to about 15 mol %.

5. The electrode active material of claim 1 further comprising a carbon coating comprising carbon atoms being sp2 hybridized, sp3 hybridized, or combinations thereof.

6. The electrode active material of claim 1, wherein the D₅₀ is from 1 μm to 5 μm.

7. The electrode active material of claim 1, wherein the electrode active material has a particle size distribution characterized by a D₁₀ is from 100 nm to 0.6 μm.

8. The electrode active material of claim 1, wherein the electrode active material has a particle size distribution characterized by a D₉₀ is from 1.7 μm to 25 μm.

9. A cathode active material comprising:
a core phase of formula LiFePO₄; and
a secondary phase of a compound of formula LiM²_{z}PₚO_{p′} at or near the surface of the core phase;
wherein:
z is 1, 2, or 3;
p is 1, 2, 3, or 4;
p′ is an integer from about 1 to about 16;
M² is Co, Cr, Gd, In, Mn, V, Zr, or a mixture of any two or more thereof;
M² is present in the cathode active material from about 0.1 to about 15 mol %;
the cathode active material exhibits an increased ionic conductivity compared to LiFePO₄ without the secondary phase; and
the cathode active material has a particle size distribution characterized by a D₅₀ greater than or equal to 1 μm.

10. The cathode active material of claim 9, wherein the compound of formula LiM²_{z}PₚO_{p′} is Li₃Mn₃(PO₄)₄, LiVP₂O₇, LiGd(PO₃)₄, LiMn(PO₃)₄, LiCo(PO₃)₄, Li₃Cr₂(PO₄)₃, LiCo(PO₃)₃, LiCoPO₄, LiV(PO₃)₄, LiZr₂(PO₄)₃, LiCrP₂O₇, LiVPO₅, LiInP₂O₇, LiFePO₄, or a mixture of any two or more thereof.

11. The cathode active material of claim 9 further comprising a carbon coating comprising carbon atoms being sp2 hybridized, sp3 hybridized, or combinations thereof.

12. The cathode active material of claim 9, wherein the cathode active material is a particulate material, and a concentration of the secondary phase is greater at a surface of the particle than at a core portion of the particle.

13. The cathode active material of claim 9, wherein the D₅₀ is from 1 μm to 5 μm.

14. A lithium ion battery cell comprising:
an anode layer;
a cathode layer; and
a separator or solid electrolyte between the anode layer and the cathode layer;
wherein:
the cathode layer comprises a particulate cathode active material comprising:
a core phase of formula LiFePO₄; and
a secondary phase of a compound of formula LiM²_{z}PₚO_{p′} at or near the surface of the core phase;
wherein:
z is 1, 2, or 3;
p is 1, 2, 3, or 4;
p′ is an integer from about 1 to about 16;
M² is Co, Cr, Gd, In, Mn, V, Zr, or a mixture of any two or more thereof;
M² is present in the cathode active material from about 0.1 to about mol %;
the cathode active material exhibits an increased ionic conductivity compared to LiFePO₄ without the secondary phase; and
the cathode active material has with a particle size distribution characterized by a Ds₅₀ greater than or equal to 1 μm; and
the cathode layer has a loading level on the current collector of greater than 15 mg/cm².

15. The lithium ion battery cell of claim 14, wherein the cathode layer has an electrode loading level from 15 mg/cm² to 25 mg/cm².

16. The lithium ion battery cell of claim 14, wherein the Ds₅₀ is from 1 μm to 5 μm.

17. A process for preparing an electrode active material, the process comprising:
forming a solution comprising a lithium source, an iron source, dopant source, and a phosphorus source in a solvent;
mixing the solution at a predetermined pH and for a period of time to form a precipitate of an intermediate precursor;
collecting the precipitate; and
annealing the precipitate at an elevated temperature to form a doped lithium iron phosphate (LiM²ₓFe₁₋ₓPO₄) compound, where M² is the dopant and comprises a transition metal or main group metal;
wherein:
the LiM²ₓFe₁₋ₓPO₄ compound is characterized by a D₅₀ greater than or equal to 1 μm; and
x is 0.01 to 0.15.

18. The process of claim 17, wherein the lithium source comprises Li₂CO₃, Li₃PO₄, LiOH·H₂O, LiHCO₃, or mixture thereof.

19. The process of claim 17, wherein the iron source is Fe⁰, Fe₂O₃, Fe₃O₄, Fe(NO₃)₂, Fe(NO₃)₃, FeCl₂, FeCl₃, FePO₄, FeSO₄, Fe₂(SO₄)₃, or a mixture of any two or more thereof, or a hydrate thereof, and the dopant source comprises M² metal, M²_{q}O_{q′}; M²_{q}(NO₃)_{q}; M²_{q}Cl_{q}; M²_{q}(PO₄)_{q}; M²_{q}(SO₄)_{q}; or a mixture of any two or more thereof, wherein M² is Co, Cr, Gd, In, Mn, V, Zr, or a mixture of any two or more thereof, and q and q′ are individually 1, 2, 3, 4, 5, 6, or 7.

20. The process of claim 17, wherein the mixing is conducted at a pH of 1-7.
